(19) United States
(12) Patent Application Publication
(10) Pub. No.: US 2011/0096628 A1
(43) Pub. Date: Apr. 28, 2011

(54) Wireless Communication Using Customized Digital Enhanced Cordless Telecommunications (DECT) Technology in a Survey Data Acquisition System

(76) Inventor: Daniel Golparian, Tokyo (JP)

(21) Appl. No.: 12/605,625

(22) Filed: Oct. 26, 2009

(51) Int. Cl. G01V 1/22

(52) U.S. Cl. 367/77

(57) ABSTRACT

In a survey data acquisition system that acquires survey data regarding a subterranean structure, information is wirelessly communicated between a wireless survey receiver and a wireless concentrator. Wireless communication of the information uses a wireless protocol that employs slot structures defined by a Digital Enhanced Cordless Telecommunications (DECT) standard.

### TECHNICAL FIELD

The invention relates generally to wireless communication using customized digital enhanced cordless telecommunications (DECT) technology in a survey data acquisition system.

### BACKGROUND

Seismic or electromagnetic (EM) surveying can be performed for identifying and characterizing subterranean elements, such as hydrocarbon reservoirs, fresh water aquifers, gas injection reservoirs, and so forth. With seismic surveying, one or more seismic sources are placed in various locations above a land surface or sea floor, with the seismic sources activated to generate seismic waves directed into the subterranean structure.

The seismic waves generated by a seismic source travel into the subterranean structure, with a portion of the seismic waves reflected back to the surface for receipt by seismic receivers (e.g. geophones, hydrophones, accelerometers, etc.). These seismic receivers produce signals that represent detected seismic waves. Signals from the seismic receivers are processed to yield information about the content and characteristic of the subterranean structure.

EM surveying involves deployment of one or more EM sources that produce EM waves that are propagated into the subterranean structure. EM signals are affected by elements in the subterranean structure, and the affected EM signals are detected by EM receivers, which are then processed to yield information about the content and characteristic of the subterranean structure.

In a land-based survey data acquisition system, data acquired by survey receivers is transported to a central recording station (e.g. recording truck) via a communications network. Typically, this communications network includes various types of intermediate communication units (often referred to as concentrators) connected to each other and to the receivers via cables and connectors. Deploying survey receivers using cables and connectors adds to total production costs of the land-based survey data acquisition system. Moreover, cables and connectors can lead to increased failures, and therefore, can be substantial contributors to operational downtime and operational costs. Also, cables can cause environmental damage in a survey area where the survey receivers and concentrators are deployed. To eliminate as much of the cables in the system as possible, it is desirable to send data wirelessly to a recording station, either completely or at least in some parts of the system.

### SUMMARY

In general, according to an embodiment, a network architecture of a survey data acquisition system that acquires survey data regarding a subterranean structure includes wirelessly communicating information between a wireless survey receiver and a wireless concentrator, where a semi-customized protocol based on the Digital Enhanced Cordless Telecommunications (DECT) technology has been designed to provide an optimized and power-friendly communication channel for wireless transmission of data between the wireless survey receiver and a wireless concentrator.

According to another embodiment, a secondary wireless network based on the WiMAX technology connects the wireless concentrators to a central recording station.

Other or alternative features will become apparent from the following description, from the drawings, and from the claims.

### BRIEF DESCRIPTION OF THE DRAWINGS

FIG. 1 illustrates an exemplary arrangement that includes wireless survey receivers, wireless concentrators, and a central recording station, where the wireless concentrators are capable of wirelessly communicating with wireless survey receivers using a modified version of the Digital Enhanced Cordless Telecommunications (DECT) communications protocol according to some embodiments.

FIG. 2 is a schematic diagram of an arrangement of survey receivers in which exemplary layout dimensions are provided.

FIG. 3 illustrates a conventional DECT frame structure.

FIGS. 4 and 5 illustrate DECT single-slot and double-slot structures, respectively.

FIG. 6 illustrates survey data packets encapsulated in customized DECT frame slots in accordance with an embodiment.

FIG. 7 illustrates a customized DECT frame structure, according to an embodiment.

FIG. 8 is a schematic diagram of an arrangement of concentrators with associated allocated frequencies, in accordance with an embodiment.

FIG. 9 illustrates an exemplary arrangement in which primary DECT-based cells are covered by secondary WiMAX-based cells, according to an embodiment.

FIG. 10 illustrates a survey data acquisition system that includes a cellular arrangement of wireless receivers and wireless concentrators in which DECT communications according to an embodiment can be performed, and that includes WiMAX base stations for communicating with various concentrator cells, according to an embodiment.

FIG. 11 is a block diagram of a wireless survey receiver, according to an embodiment.

FIG. 12 is a block diagram of a wireless concentrator, according to an embodiment.

FIG. 13 is a block diagram illustrating communication between a central recording station and WiMAX base stations, according to an embodiment.

### DETAILED DESCRIPTION

In the following description, numerous details are set forth to provide an understanding of the present invention. However, it will be understood by those skilled in the art that the present invention may be practiced without these details and that numerous variations or modifications from the described embodiments are possible.

In accordance with some embodiments, a wireless protocol is employed for wireless communication between wireless survey receivers and wireless concentrators in a survey data acquisition system that acquires survey data regarding a subterranean structure. A “survey receiver” refers to a module that has one or more sensors for sensing signals that are affected by the subterranean structure in response to a source signal from a survey source. The survey source can be an electromagnetic (EM) transmitter or a seismic source. The sensor of the survey receiver can be an EM sensor or a seismic sensor. A “concentrator” refers to a communications module that routes data between nodes of a survey data acquisition system.

In accordance with some embodiments, the wireless protocol used for wireless communication between a wireless survey receiver and a wireless concentrator is based on the Digital Enhanced Cordless Telecommunications (DECT) technology. The DECT wireless technology is defined by a standard promulgated by the European Telecommunications Standards Institute (ETSI). The DECT wireless technology provides for short-range radio frequency (RF) communications. One example DECT standard is the ETSI EN 300 175 standard.

The term “DECT technology” or “DECT standard” or “DECT protocol” can refer to any currently defined DECT technology, or to any subsequent technologies that evolve from the current DECT technology. As will be described in more detail, the wireless concentrator and the wireless receiver provide certain functionalities similar to the ones provided by the “base station” (fixed part) and the “handset” (portable part) components of the conventional DECT technology.

Using survey receivers that incorporate chipsets for the DECT protocol allows costs of the survey receivers to be kept at a reasonable level, since existing chipsets can be used with modifications made according to some embodiments for optimized performance. The DECT technology is a “high volume” technology in that chipsets that implement the DECT technology are generally available at relatively low prices. The DECT standards provide a good basis for implementation of wireless telemetry in a survey data acquisition system, from both a system requirement point of view as well as from a cost point of view.

Selection of a wireless technology for a land-based survey system can be difficult due to the fact that requirements for such a system are different compared to requirements for data or telecommunications systems for which most of the existing wireless technologies have been designed and developed. Furthermore, although a wireless communications technology can solve many of the problems associated with cables, the wireless technology may also introduce some new challenges, including power management. In a wire-based system, power is distributed among large groups of receivers from power distribution units through wires. The power distribution units can in turn be connected to batteries or other sources of power like solar panels. In a wire-based system, hundreds of receivers can receive their power from one such power distribution unit. As a result, when batteries of the power distribution units need to be recharged, only a small number of power distribution units need to be collected for recharge.

In a wireless system, on the other hand, every survey receiver will have its own battery. In a large system including thousands of survey receivers, all these batteries will need to be recharged at some point. Furthermore, the weight of the battery adds to the total weight of the survey receivers, and if too heavy will cause slower deployment (placement and replacement). Therefore, low power consumption (which leads to longer battery life) is an important requirement for a wireless land-based surveying system.

The wireless protocol used according to some embodiments of the invention is a modified version of a standard DECT protocol. More specifically, the wireless protocol used by some embodiments of the invention includes a medium access control (MAC) layer that is a modified version of the MAC layer of a standard DECT protocol, for use in a land-based survey system. The MAC layer is part of the data link layer specified by the Open Systems Interconnection (OSI) model, which is an abstract description for layered communications and network protocol design. The MAC layer provides addressing and channel access control mechanisms, among others, to enable nodes on the network to communicate. The modified MAC layer (of the survey receivers and wireless concentrators) according to some embodiments uses DECT slot structures to wirelessly communicate data.

A benefit of using the modified DECT protocol as the wireless protocol for communications between survey receivers and wireless concentrators is that DECT employs a time division multiplexing access (TDMA) mechanism, in which wireless survey receivers communicate in pre-assigned time slots, both in the uplink direction (from wireless survey receivers to wireless concentrators) and in the downlink direction (from wireless concentrators to wireless survey receivers). DECT has a built-in TDMA mechanism, which can be advantageously leveraged for communications between survey receivers and concentrators.

TDMA allows for avoidance of contention between multiple wireless survey receivers that results in packet collisions (in which data packets from multiple wireless survey receivers that are transmitted at the same time collide). Use of a contention-based medium access mechanism for wireless communications between wireless survey receivers and wireless concentrators is not practical in the context of a survey data acquisition system. Since a wireless concentrator will typically have a relatively large coverage radius (e.g. 50 meters), using a traditional CSMA/CA (carrier sense multiple access/collision avoidance) mechanism it is likely that wireless survey receivers will not be able to hear each other's transmissions such that the possibility of multiple wireless survey receivers transmitting at the same time is enhanced, resulting in packet collisions and increased overhead for retry transmissions.

Using the TDMA technique of DECT, on the other hand, wireless survey receivers communicate only during assigned time slots. The time slots for the wireless survey receivers (portable parts) are assigned by the concentrator (fixed part). However, the existing DECT standard, as it stands currently, cannot be used; as a result, in accordance with some embodiments, modifications of the DECT standard are provided to enable an optimal solution for the survey data acquisition application.

The following provides a discussion of some features of a DECT MAC layer. The MAC layer is responsible for many aspects of the DECT service. There are some services of the MAC layer that are intimately related to the operation of the PHY (physical) layer (which is the layer below the MAC layer in the OSI model). The PHY layer provides the concept of a bearer which is specified as the combination of an RF frequency in conjunction with a given time slot. In other words, the bearer is specified as an RF channel number and a time slot number.

The MAC layer is responsible for taking a data stream from a higher layer and creating a block of data to send to the PHY layer bearer. In the reverse direction, the MAC layer accepts a block of data from the PHY layer bearer, recovers the data from the block, and passes it to the higher layers.

The MAC layer is also responsible for multiplexing and de-multiplexing the data block and mapping data of the data block between the PHY layer and the correct logical channels. These logical channels include control channels and data channels (that carry data such as digitized voice).

The MAC layer has the concept of a connection service. The MAC layer is responsible for selecting, controlling and maintaining one or more bearers to support a continuous connection for an end-to-end service (e.g. a duplex voice telephone call). Conventionally, the MAC layer in the handset uses information such as signal quality to decide when to perform a bearer handover and maintain the integrity of the connection.

The conventional MAC layer also supports broadcast services in the form of a beacon which broadcasts system information from every base station (fixed part) to every handset (portable part). Every handset needs to be informed about the network in which it operates both before the handset is allowed connection to the network and also once the handset is connected to the network.

The following describes modifications according to some embodiments to the DECT MAC layer as conventionally defined. The data rate per bearer for conventional DECT is higher than required for survey receiver-concentrator communications. Therefore, a first modification of the MAC layer is that the data rate per bearer is reduced so that the number of bearers supported by one RF frequency is increased.

Also, the symmetric nature of the frame structure for conventional DECT is not optimal for survey receiver-concentrator communications. A better use of the spectrum is to have a much greater bandwidth on the uplink for seismic data transport from the survey receiver to the concentrator. The downlink information is predominantly control and acknowledgement data, and thus, there is usually much less downlink information than uplink information.

A second modification is that the DECT frame structure has been made asymmetric, with the majority of the slots being allocated in the uplink. This increases the number of connections supported by one RF bearer.

Because the downlink control channels may now be very low data rate channels (because there are only a few downlink slots), the downlink slots can carry control information by a broadcast method in accordance with some embodiments. For example the downlink slots can carry information for many survey receivers and each survey receiver will only read the information in the downlink slot relevant to it.

Although not directly part of the slot structure, the handover mechanism of conventional DECT has an indirect effect on the design of the slot structure. In conventional DECT the bearer is made from the combination of an RF frequency and a time slot. Conventionally, each handset (which would correspond to the survey receiver in the survey data acquisition system context) maintains a table of available frequency/time slot pairs and ranks them according to the residual signal level in each pair. To obtain this information the handset scans the available spectrum during the period it is not in connection. This consumes battery power.

When a handover is required then the handset uses this information to decide which frequency/time slot pair (a bearer) has the best chance of a good connection. This is especially important for mobility applications and requires then quite a large number of frequency/time slot pairs are left free for handover.

However, in the survey context, the survey receivers are static (not mobile). According to a third modification of the MAC layer, each survey receiver will communicate over just one RF carrier. As will be described this will be the RF carrier assigned to the concentrator covering the coverage area in which the survey receiver is located.

In some embodiments, RF carriers are pre-allocated to wireless concentrators by an operator of the survey data acquisition system. Such pre-allocation of RF carriers provides more efficient use of the resource in the survey application. The frequencies are allocated to the concentrators by the recording station 110 during system initialization, based on predetermined configuration information provided to the recording station 110.

Due to the third modification described above, only TDMA is used per RF carrier. In other words, each concentrator communicates over a single frequency with a given group of survey receivers, and thus the frequency division multiplexed access (FDMA) conventionally provided by DECT is not used.

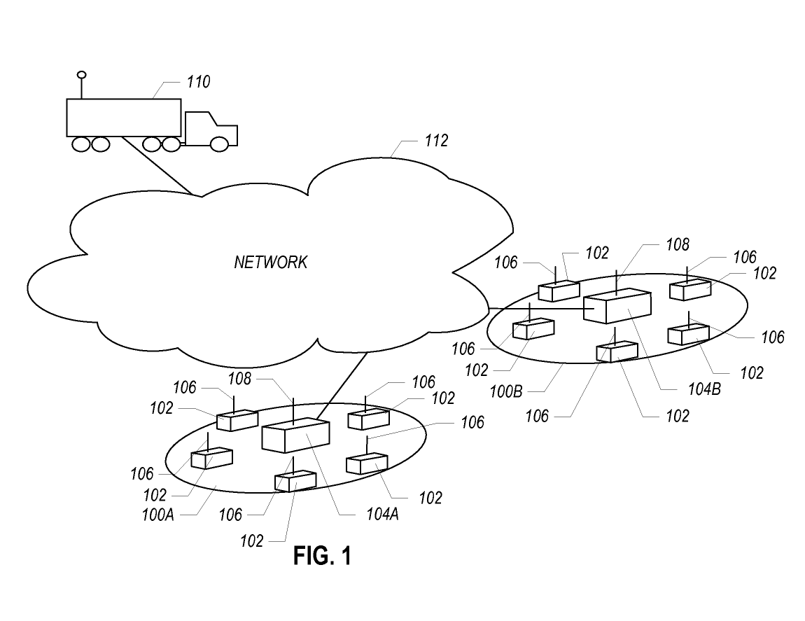

FIG. 1 illustrates an exemplary arrangement that includes wireless survey receivers 102 that are able to communicate wirelessly with wireless concentrators 104A and 104B in a cellular arrangement. The wireless receivers 102 each includes an antenna 106 for communicating wirelessly with a corresponding antenna 108 of the wireless concentrator 104A or 104B.

Each of the wireless concentrators 104A and 104B has a respective coverage area 100A and 100B in a cellular arrangement. The “coverage area” (also referred to as a “cell”) of a wireless concentrator refers to a geographic region in which the wireless concentrator is able to communicate wirelessly with a wireless survey receiver.

As noted above, the wireless communication between wireless survey receivers 102 and respective wireless concentrators 104A, 104B is according to a customized wireless protocol that is based on the DECT technology. As depicted, in addition to the DECT-based cellular network, another communications network 112 is provided to relay data between the survey receivers and a central recording station 110. The communications network 112 can be implemented as a wired network, a wireless network, or a combination of a wired and wireless network (a hybrid network). A specific implementation of the communications network 112 is described further below.

An example of the recording station 110 is a recording truck. The recording station 110 receives measurement data from the wireless survey receivers 102 through the wireless concentrators 104A, 104B, and through the communications network 112. The recording station 110 includes a storage subsystem to store the received measurement data. The recording station 110 is also responsible for management of the survey receivers and concentrators, as well as the network. The field crew working in the recording station can initiate shots, monitor the spread, and initiate tests and cause control messages to be sent to the survey receivers and concentrators. The recording station can also include modules that control the spread and the communications network automatically, without any human intervention.

By employing wireless communication between wireless survey receivers 102 and wireless concentrators 104A, 104B, cables do not have to be provided between the wireless survey receivers and wireless concentrators. Since a survey data acquisition system can include thousands of wireless survey receivers, even the elimination of cables only between wireless survey receivers and wireless concentrators (while implementing the network 112 with cables) can provide a significant reduction of the total amount of cables. In a typical exemplary survey data acquisition system, greater than 70% of the cables in the system are the ones that connect the receivers to the first level of concentrators. Eliminating a large number of cables can reduce production costs, as well as reduce likelihood of failures due to cable failure.

Although two wireless concentrators and respective coverage areas are depicted in FIG. 1, it is noted that a survey data acquisition system can include more than two wireless concentrators and respective coverage areas. As mentioned above, note that each coverage area 100A, 100B can also be referred to as a “cell.” Thus, in accordance with some embodiments, a cellular arrangement for wireless communications is provided, where the wireless survey receivers communicate in respective cells with a corresponding wireless concentrator.

The survey data acquisition system depicted in FIG. 1 is a real-time survey data acquisition system, in which survey data acquired by the survey receivers 102 are communicated through the concentrators for receipt by the recording station 110 on a real-time basis. A “real-time” survey data acquisition system refers to a survey data acquisition system in which data is communicated from survey receivers, either directly or indirectly through one or more concentrators, to the recording station 110 within acceptable delay limits. An “acceptable delay limit” refers to a delay in communication of survey data from a survey receiver to a recording station (directly or indirectly) within an amount of time in which an operator is able to determine whether or not the particular “shot” (activation of a survey source such as a seismic source of EM source) has resulted in the acquisition of data that is acceptable (that meets one or more predefined criteria of the operator). In other words, the delay is short enough to allow discovery of bad quality data (for example, due to environmental noise) in the recording station, followed by relatively quick initiation of a new shot (activation of a survey source for a predefined period of time and recording of the measurement data from the survey receivers during that period). Due to logistics involved in land-based survey operations, relocating survey sources and repeating shots is time consuming and adds to the total cost of operation.

A real-time survey data acquisition system is superior to a system in which data is recorded in non-volatile memory in each survey receiver and then later is retrieved. With this latter system (often referred to as autonomous system), there is no way to discover bad-quality data until the data is retrieved from the receivers at the camp. This means that to re-shoot the shots, all the receivers and sources would have to be brought back to their original locations to repeat new shots, which is extremely costly.

For the survey data acquisition system to operate in wireless mode, communications between the wireless concentrators and the recording station over the communications network 112 should also support real-time communications. As discussed further below, the WiMAX technology can be employed to implement the backhaul connection between the wireless concentrators and the recording station 110. WiMAX is one possible technology that can support real-time communications.

As noted above, the MAC layer of the customized wireless protocol is designed by modifying the MAC layer of the standard DECT protocol. The MAC layer is implemented as firmware stored in a non-volatile memory of DECT chipsets. The MAC layer can be modified by modifying the firmware in the chipset. Modifying the firmware is accomplished by reprogramming the non-volatile memory inside the chipset. The remaining layers of the DECT protocol can remain unchanged.

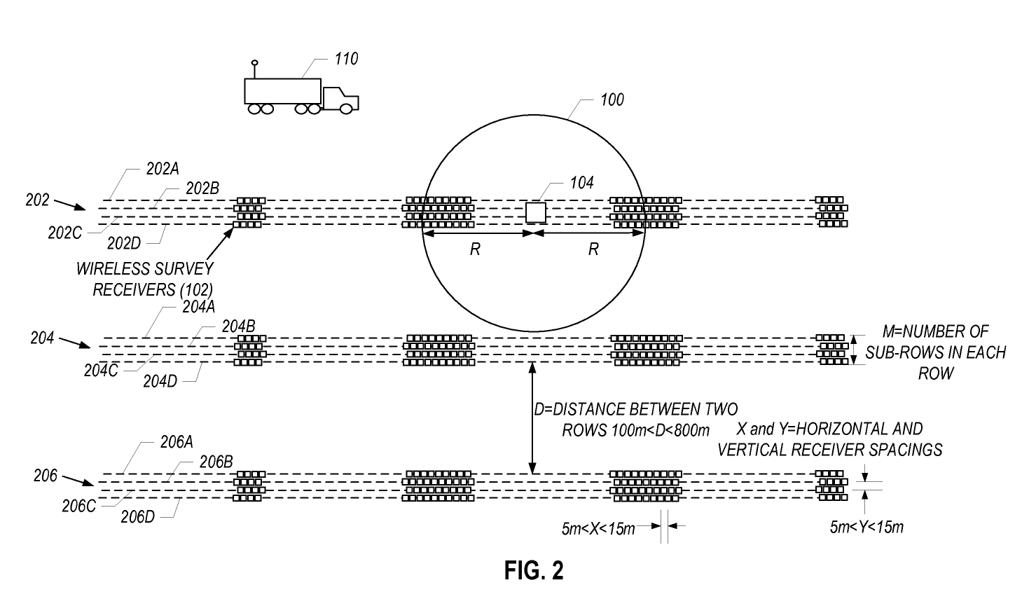

FIG. 2 shows an exemplary arrangement of survey receivers, where the arrangement includes multiple rows 202, 204, and 206 of receivers. There can be more rows of wireless survey receivers (not shown in FIG. 2). Each row of receivers includes M (e.g. 1≦M≦4) sub-rows of receivers. For example row 202 includes sub-rows 202A, 202B, 202C, and 202D; row 204 includes sub-rows 204A, 204B, 204C, and 204D; and row 206 includes sub-rows 206A, 206B, 206C, and 206D. In FIG. 2, exemplary horizontal spacings (X) and vertical spacings (Y) of receivers are also provided. Also, exemplary distances D between rows are provided. The arrangement of FIG. 2 is provided for purposes of example only. In other implementations, other arrangements of wireless survey receivers can be provided.

In FIG. 2, the survey receivers are represented as small square boxes. FIG. 2 also shows a wireless concentrator 104 (larger box) that has a coverage area 100. The radius of coverage is represented as R in FIG. 2, where R can be 50 meters or some other value. Other wireless concentrators (not shown) are also provided in the arrangement of FIG. 2 to provide coverage in other coverage areas 100.

In one exemplary dense arrangement, with an exemplary cell radius of 50 meters, each concentrator can be associated with 80 survey receivers (40 survey receivers on each side). To provide such dense arrangement, the following dimensions are employed: minimum receiver spacing (5 m), and maximum number of sub-rows (4).

In each cell (100) of the survey data acquisition system, the majority of data that has to be transmitted is the acquired survey data from the wireless survey receivers in the uplink direction (from the receivers to the concentrators to the recording station). The amount of downlink data (from the recording station or concentrators to wireless survey receivers) is much less than the amount of uplink data. Thus, the TDMA-based wireless protocol according to some embodiments allocates a larger number of time slots in the uplink direction than in the downlink direction.

In one exemplary implementation, with 2-ms sampling and 24-bit samples, 12 kbps of raw data rate is required for each uplink time slot. In other implementations, other data rates may be employed.

Various example numbers have been provided above and in FIG. 2; in other implementations, other numbers can be used.

In addition to time slots for communicating data (referred to as data slots), time slots are also allocated for communicating other information. For example, in the downlink direction, control messages are sent to perform various tasks, such as to initiate a self test at a receiver, or to perform some other management related task. The downlink control messages can be sent to individual receivers, or to a group of receivers (multicast or broadcast).

In the downlink direction, downlink control slots are assigned to communicate acknowledgment messages, such as to acknowledge receipt of survey data received in uplink slots. Such downlink control slots can also be used to communicate other messages.

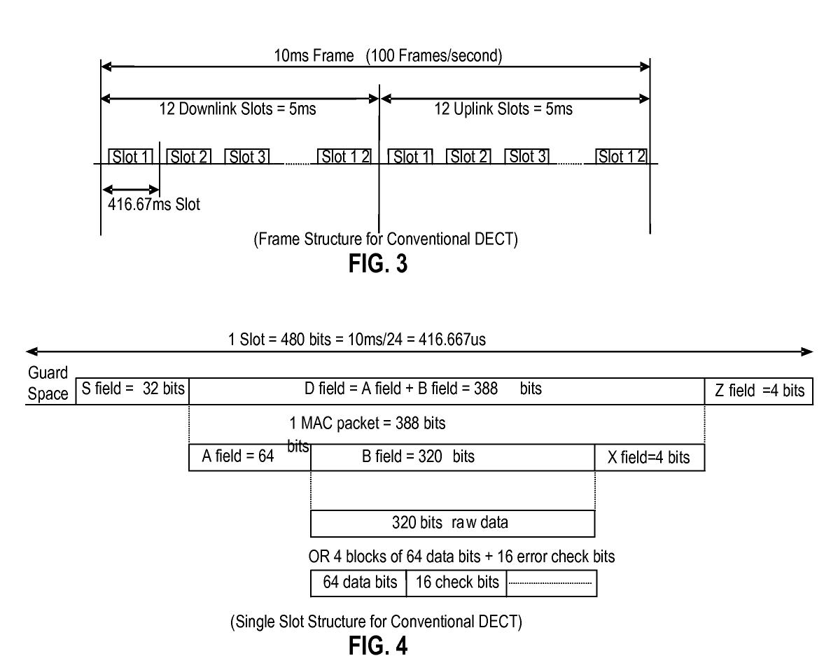

FIG. 3 shows a conventional structure of a DECT frame when configured for duplex 32-kbps (kilobits per second) voice to support 12 bidirectional connections. The signaling rate is 1.152 Mbps (megabits per second) (with frequency shift keying) and the channel bandwidth used is 1.728 MHz (megahertz). In Europe the original frequency allocation was 1880 to 1900 MHz with 10 channels allocated. Other bands have also been defined but the most common other band supported is that for the U.S. market covering 2400 to 2483.5 MHz with 45 channels allocated.

With a frame length of 10 ms (milliseconds) (100 frames/second) and a slot length of 416.667 μs (microseconds), each slot is 480 bits long (including guard time) of which 320 bits are data. Thus with 100 frames/second each connection supports 32 kbps. As depicted in FIG. 3, each frame has 12 uplink slots and 12 downlink slots and thus the latency is 10 ms (i.e. length of the frame). This is a requirement for good speech. However, as noted above, the symmetric conventional DECT frame structure is not suitable for communications between survey receivers and concentrators.

Each RF channel supports this time slot structure so each connection (excluding the period during bearer handover) occupies a given time slot on a given RF frequency.

FIG. 4 illustrates a single-slot structure for DECT. Each slot is made up of the following elements:
A preamble and synchronization field, the “S” field, of 32 bits.
An “A” field which transports multiplexed control channels of 64 bits.
A “B” field of either protected or unprotected data of 320 bits. Note that the combination of the “A” field and the “B” field are collectively known as the “D” field.
An “X” field of 4 bits for error checking
A “Z” field of 4 bits also for error checking.

The slot structure can also be defined for double-slot, half-slot operation and no data field operation. A double-slot structure uses the same header information and thus a higher data throughput since over each frame only half the header information needs to be transmitted.

The exact specification of the slot structure of FIG. 4 is described in ETSI EN 300 175-2 v2.1.1. This specification allows many variations on the basic formats but it should be noted that only the main formats have typically been implemented and are supported by existing and available hardware.

Sometimes just beacon transmission can occur (when no connections to the concentrator exist such that the “B” field for data is not used and only the “S” field and the “A” field are transmitted). When connections are made, the beacon information is part of the multiplexed “A” field.

The 64-bit “A” field is further split into an 8-bit header, 40 bits of multiplexed control channels and a 16-bit CRC (cyclic redundancy check) field. The “A” field is well protected and provides a 4-kbit/second bidirectional channel for the control and broadcast information in DECT.

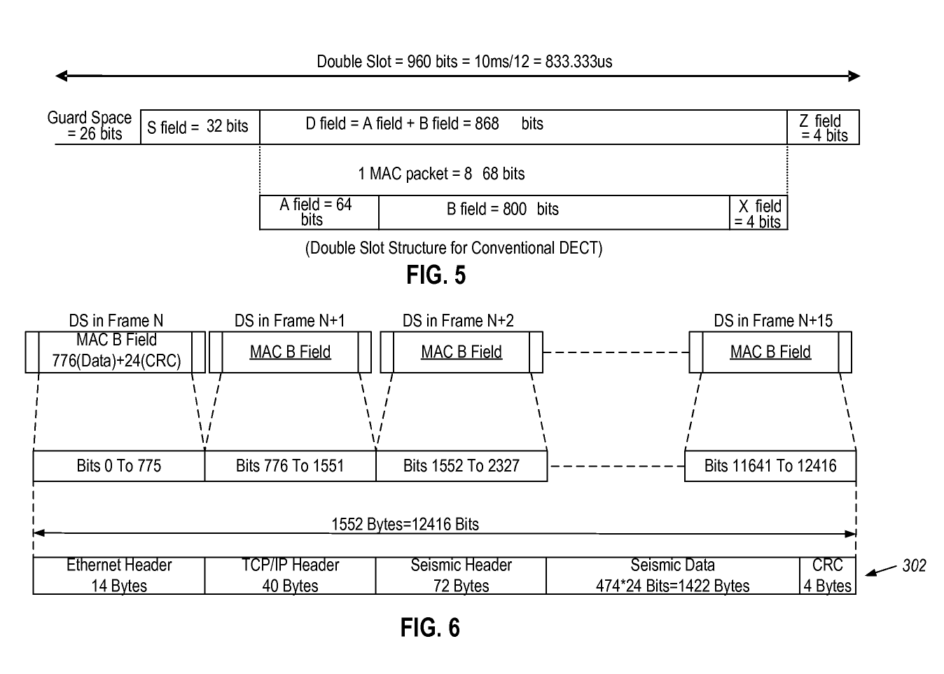

As mentioned, DECT also defines a double-slot structure, which reduces the overhead and allows an overall higher data transport capacity. This double-slot structure is depicted in FIG. 5.

With the double-slot structure, the guard time, “S” field, “A” field, “X” field and “Z” field are only used once per double slot, which means that the “B” field, used for data transport, does not just double to 640 bits but increases to 800 bits.

In accordance with some embodiments, the double-slot structure defined by DECT can be advantageously used for communicating survey data at a relatively large bandwidth. However, in other implementations, it is noted that the single-slot structure defined by DECT can also be used.

FIG. 6 illustrates an exemplary encapsulation of a survey data packet using DECT double-slot structures. The double-slot structure is provided in each of the frames N, N+1, N+2, . . . , N+15, depicted in FIG. 6. The survey data, which can be survey data associated with a TCP/IP (Transmission Control Protocol/Internet Protocol) packet, can be broken up into multiple chunks (each of length 776 bits). Thus, frame N carries bits 0-775, frame N+1 carries bits 776-1551, and so forth. Each collection of 776 bits of survey data is placed into a respective 800-bit, double-slot container (the structure depicted in FIG. 5). An added 24 bits of CRC information fill up the remainder of the double-slot container.

The survey data packet that is encapsulated in frames N to N+15 is represented as 302 in FIG. 6. The survey data packet 302 includes a total of 1,552 bytes (or 12,416 bits) of information. The survey data packet 302 includes an Ethernet header (14 bytes), a TCP/IP header (40 bytes), a seismic header (72 bytes), seismic data (1,422 bytes), and CRC data (4 bytes). Note that this is just an exemplary structure for the data packet, and that the data packet may have other structures.

Note that the survey data packet 302 is communicated in the uplink from a survey receiver to a concentrator.

The modified DECT frame structure can support the 12 kbps data rate requirement of the exemplary receiver implementation (i.e. 2-ms sampling and 24-bit samples) mentioned earlier with substantial overhead. The overhead accounts for packaging (such as Ethernet and TCP/IP packaging) as well as to allow retry and/or forward error correction (FEC) to be employed.

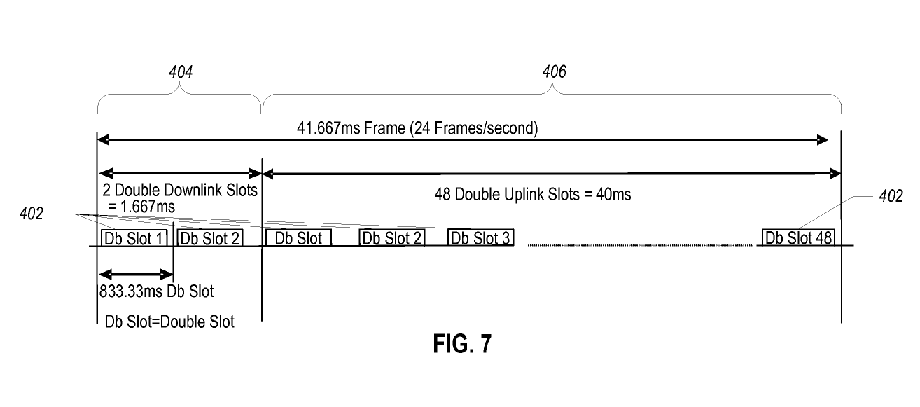

FIG. 7 illustrates an exemplary customized frame structure that has been modified from the conventional DECT frame structure. The frame structure depicted in FIG. 7 uses double-slot structures (depicted as double slots 402). The double slots 402 are divided into downlink slots and uplink slots, where the set of downlink slots is represented as 404, and the set of uplink slots is represented as 406. Each double slot 402 includes 776 bits of survey data and 24 bits of CRC information to fill out 800-bit blocks in the double-slot format. The duration of each double slot is 833.33 μs. The frame structure of FIG. 7 supports a total of 50 slots on one RF frequency giving a frame length of 41.667 ms. With a frame length of 41.667 ms, there will be 24 frames in one second.

The 50 slots are used to support both uplink and downlink, with 48 uplink slots and 2 downlink “broadcast-like” slots (e.g. to broadcast control messages). The information provided in the downlink slots primarily includes control information and uplink data acknowledgements (to acknowledge receipt of uplink data).

If the survey receiver is generating data with a raw data rate of 12 kbps, and if the added overhead as depicted in FIG. 6 makes up 130 bytes per 1,422 bytes of survey data, then a minimum data rate of 13.1 kbps is required to send the data from the survey receivers in real time (i.e. 12 kbps plus 9.1% overhead). In the implemented frame structure, each 776 bits of survey data is repeated once every 41.667 ms, which provides a channel data rate of 18,624 kbps.

This data rate allows for a retry rate of 1 in 4 (i.e. 25 percent of the available bandwidth), which may be used during poor transmission conditions. With such a retry frequency, the total useful bandwidth is reduced to 13.968 kbps, which is still higher than the required 13.2 kbps for real-time transmission of the survey data.

Note that the various values used above are provided for purposes of example. In other implementations, other values can be used.

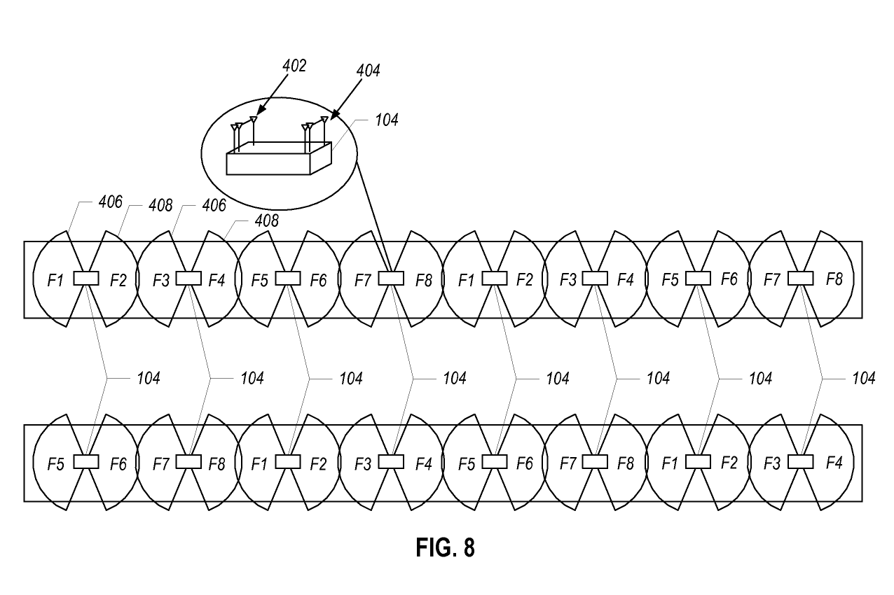

FIG. 8 depicts an exemplary arrangement of concentrators 104 in plural rows of survey receivers. In one implementation, an exemplary cell radius (R in FIG. 2) is 50 meters. In such an implementation, each concentrator 104 can cover 80 survey receivers (40 on each side). To do so, each concentrator 104 is equipped with several (two in one example) DECT chipsets and their associated RF circuitry and antenna subsystem. Through the modification provided in the MAC layer, each chipset is tied to just one RF carrier. The customized frame structure (depicted in FIG. 7) provided on a single RF carrier will allow communication with 48 survey receivers per each DECT interface (formed of one DECT chipset and associated RF circuitry and antenna subsystem). The two DECT interfaces implemented on each wireless concentrator 104 will allow 96 receivers to be associated with each concentrator. This allows for some excess capacity (16 survey receivers) for each concentrator.

FIG. 8 also illustrates a distribution of eight RF carriers (having frequencies F1-F8). Other examples may include other numbers of RF carriers. As depicted in FIG. 8, each concentrator 104 includes two antenna subsystems 402 and 404, where each antenna subsystem 402, 404 is a directional antenna subsystem. Thus, as illustrated, each concentrator 104 provides two directional sub-coverage areas, represented as 406 and 408 in FIG. 8, where each sub-coverage area is associated with a corresponding different frequency. The two sub-coverage areas 406 and 408 together make up a coverage area 100 (FIG. 1) of a concentrator 104.

The concentrators 104 are provided in multiple rows (two depicted in FIG. 8). In the first row, the first concentrator 104 (on the left side of the drawing) has a first sub-coverage area 406 in which frequency F1 is used, and a second sub-coverage area 408 in which frequency F2 is used. The next concentrator 104 in the first row uses frequencies F3 and F4 in respective sub-coverage areas 406 and 408. This pattern continues, until at the fifth wireless concentrator in the first row, frequencies F1 and F2 are reused. The reuse pattern then continues along the first row.

In the second row, the first concentrator 104 (on the left side of the drawing) uses frequencies F5 and F6, rather than frequencies F1 and F2, in respective sub-coverage areas 406 and 408. The next concentrator 104 in the second row uses frequencies F7 and F8, and so forth. Thus, the frequency reuse pattern in the second row in FIG. 8 is shifted with respect to the frequency reuse pattern in the first row, which helps to reduce co-channel interference between different concentrators. In one embodiment, the frequency reuse pattern in one row can be a shifted version of a frequency reuse pattern in an adjacent row. Furthermore, the use of directional antenna subsystems in each concentrator also helps to reduce co-channel interference.

The above has described the use of a modified version of DECT for wireless communication between wireless survey receivers and wireless concentrators. In accordance with some embodiments, an additional layer of connectivity is added to the DECT layer to implement the survey data acquisition system. In some implementations, the additional layer is according to the WiMAX (Worldwide Interoperability for Microwave Access) technology, as defined by IEEE 802.16. WiMAX is a communications technology that provides for wireless transmission of data in a variety of ways, ranging from point-to-point links to full mobile cellular-type access. WiMAX allows for efficient bandwidth use, interference avoidance, and is intended to allow higher data rates over longer distances. These features make WiMAX a good candidate for implementation of the backhaul connection that connects the wireless concentrators to the recording station in the survey data acquisition system.

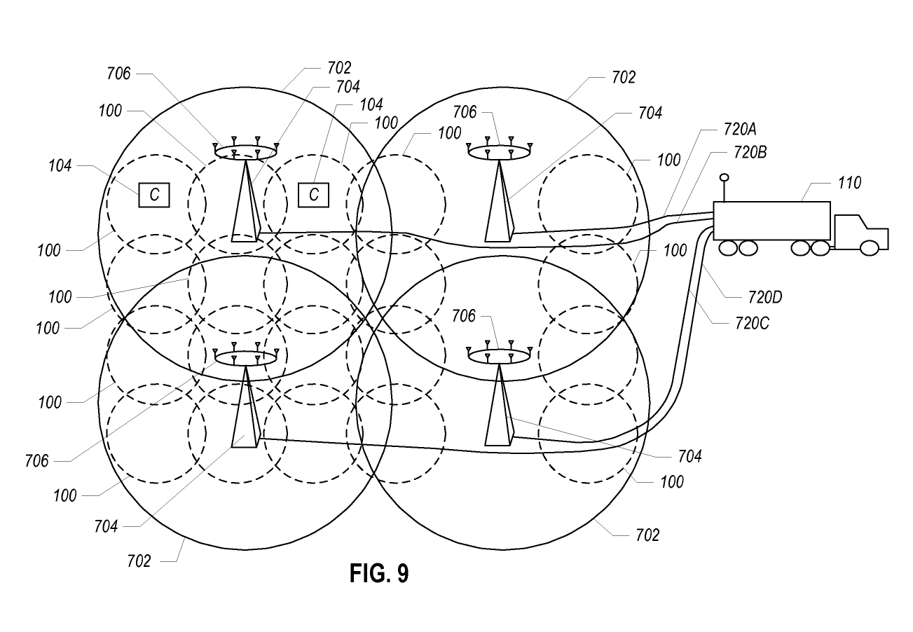

FIG. 9 shows a secondary cell-based architecture that is built upon the primary cell-based architecture using DECT. As shown in FIG. 9, cells 100 are provided, where each cell 100 is the coverage area of a respective wireless concentrator 104 (denoted “C” in FIG. 9). The cells 100 are referred to as DECT cells, which are part of the primary cell-based architecture.

The secondary cell-based architecture includes WiMAX cells 702, which include the coverage areas of respective WiMAX base stations 704. Thus, each WiMAX base station 704 is able to communicate with wireless concentrators 104 in the respective WiMAX cell 702. The WiMAX base station 704 includes a sectorized antenna structure 706 for performing the wireless communications with the wireless concentrators 104.

The WiMAX base stations 704 are in turn connected to the central recording station 110. In the example of FIG. 9, the connections between the WiMAX base station 704 and the recording station 110 are wired connections 720A, 720B, 720C, and 720D. Alternatively, the WiMAX base stations 704 can communicate wirelessly with the recording station 110.

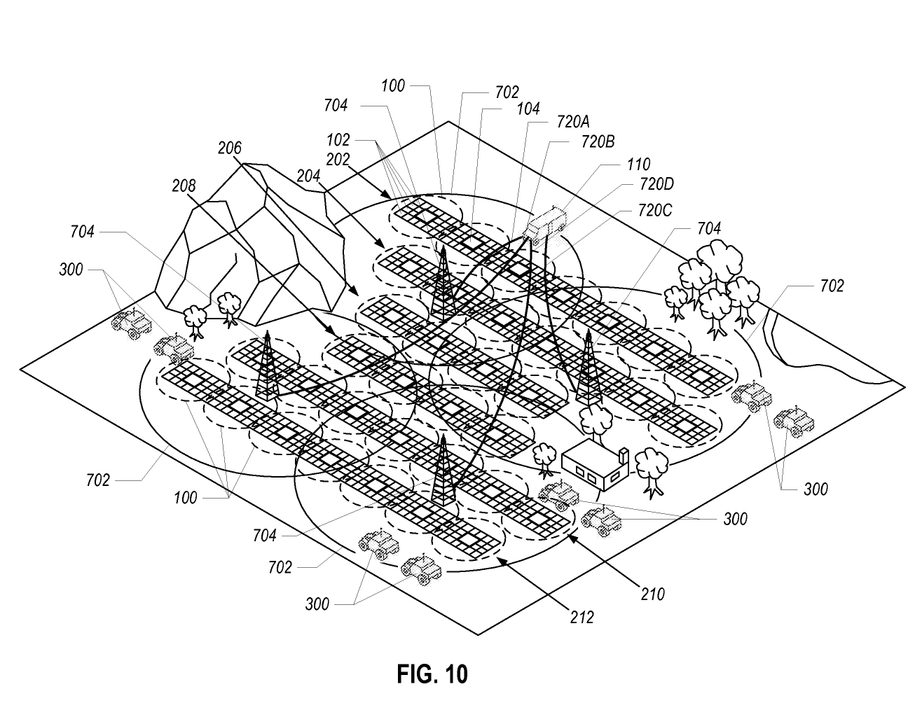

FIG. 10 is view of a survey data acquisition system, which includes multiple rows 202, 204, 206, 208, 210, and 212 of wireless survey receivers 102 and wireless concentrators 104 (the wireless survey receivers are represented by smaller boxes, whereas the wireless concentrators are represented by the larger boxes). The smaller dashed circles in FIG. 10 illustrate the coverage areas 100 of respective wireless concentrators. Also depicted in FIG. 10 are various survey sources (e.g. seismic vibrators) 300, and the recording station 110.

FIG. 10 also shows WiMAX cells 702 (larger circles) and respective WiMAX base stations 704.

As soon as wireless concentrators 104 are powered up and initialized, they start sending beacons to the wireless media over dedicated RF channels that are distributed among them by the central recording station 110.

As soon as a wireless receiver 102 wakes up, it starts scanning the wireless medium, and will eventually sense beacons from one or several wireless concentrators 104. Each wireless receiver will then report a list of the detected wireless concentrators to the recording station 110. In order to send this information to the recording station, the wireless receiver will randomly select one of the detected wireless concentrators. The recording station will eventually receive the results of the scans from all of the wireless receivers and run an optimization algorithm to distribute the wireless concentrators among them. The result of the optimization algorithm is then sent back to the wireless receivers. As soon as this information is received by a wireless receiver, it will start associating with the wireless concentrator that is assigned to it on a single dedicated RF channel. To conserve power, an efficient power saving mechanism has been implemented. In the mechanism, wireless receivers stay in the sleep mode most of the time, and wake up only for short periods of time corresponding to their dedicated uplink and downlink time slots. This reduces the power consumption considerably.

In the exemplary implementation of FIG. 10, the communication links 720A, 720B, 720C and 720D between the WiMAX base station 704 and the recording station 110 are implemented using fiber optic connections, such as gigabit Ethernet connections running on single-mode optical fiber. In smaller areas where the distances between the WiMAX base stations 704 and the recording station 110 can be covered by point-to-point wireless links, such as Millimetric Wireless or Free Space Optic, the wireless links can potentially replace the fiber optic connections between the WiMAX base stations and the recording station.

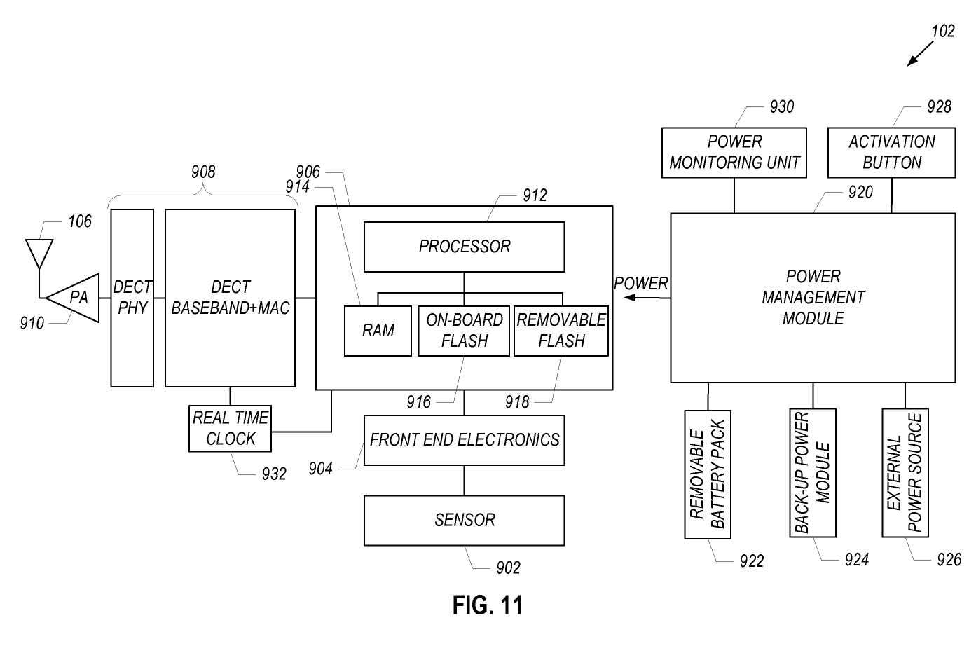

FIG. 11 is a block diagram of components within a wireless survey receiver 102, according to an embodiment. The wireless survey receiver 102 includes a sensor 902 (e.g. EM sensor or seismic sensor) that is electrically connected to front-end electronic circuitry 904 (which can include an analog-to-digital converter, signal amplifier, and/or other electronic circuitry) for processing measurement data received from the sensor 902. The measurement data processed by the front-end electronic circuitry 904 is sent to a central processing unit (CPU) 906.

The CPU 906 is in turn connected to a DECT chipset 908, which is connected through an amplifier 910 to the antenna 106. The DECT chipset 908 may include one or more chips (such as a baseband plus MAC chip and a PHY chip) to enable provision of the modified DECT wireless protocol described above.

As further depicted in FIG. 11, the CPU 906 includes a processor 912 that may be connected to a random access memory (RAM) 914 (or other type of volatile memory), an on-board flash memory 916 (or other type of non-volatile memory), and a removable flash memory 918 (or other type of non-volatile memory). The processor 912 is able to execute software instructions to allow the wireless receiver to perform its tasks, which includes collection of measurement data. The processor 912 also provides part of the communications stack to support the modified DECT protocol.

The wireless survey receiver 102 also includes a real-time clock 932. The real-time clock 932 provides time from which time stamps are generated for association with survey data sent on the uplink. The real-time clock 932 can be time synchronized with other real-time clocks in other wireless survey receivers, based on synchronization information included in the beacons received on the downlink.

In a real-time mode of operation, the CPU 906 is able to transmit survey data through the DECT chipset 908 for wireless communication over the antenna 106 to a wireless concentrator for delivery to the recording station 110. However, under certain scenarios, such as due to loss of wireless links (e.g. excessively high data error rates present), or failure of communications equipment, the real-time mode of operation may not be possible. In such a situation, the survey data acquisition system can operate in non-real-time mode.

In non-real-time mode, a wireless survey receiver is able to store survey data in the removable flash memory 918. The survey data stored in the removable flash memory 918 can later be retrieved and merged with the real-time data.

Alternatively, the wireless survey receiver 102 can be divided into two parts: a fixed part and a removable part. The removable part can be sent back to camp for data download, while the fixed part stays in the field. Further details regarding such a wireless survey receiver is provided in U.S. patent application Ser. No. 12/255,685, entitled “A Sensor Module Having Multiple Parts for Use in a Wireless Survey Data Acquisition System,” (Attorney Docket No. 14.0430), filed Oct. 22, 2008.

The wireless survey receiver 102 also includes a power management module 920 that receives power from one of various sources: a removable battery pack 922, a backup power module 924, and an external power source 926. The power management module 920 supplies power to the other components of the wireless survey receiver 102.

The backup power module 924 can provide power when the battery pack 922 is unavailable. The backup power module 324 can be in the form of a battery, a super-capacitor, or other energy source.

Also depicted in the example of FIG. 11 is an activation button 928 that is connected to the power management module 920. A user can actuate the activation button 928 to turn on or turn off the wireless survey receiver 102.

It is important to use the battery's limited energy in an efficient way. The activation button 928 will be typically turned on after a field crew has placed the sensors at their planed positions. Prior to the final placement of the sensor modules, the activation button 928 will be turned off to save power.

As further depicted in FIG. 11, a power monitoring unit 930 is included in the wireless survey receiver 102. The power monitoring unit 930 includes one or several mechanisms, such as LEDs (light emitting diodes) or buzzers, connected to the power management unit 930, which can indicate the status of different power sources to a field crew or to indicate other information.

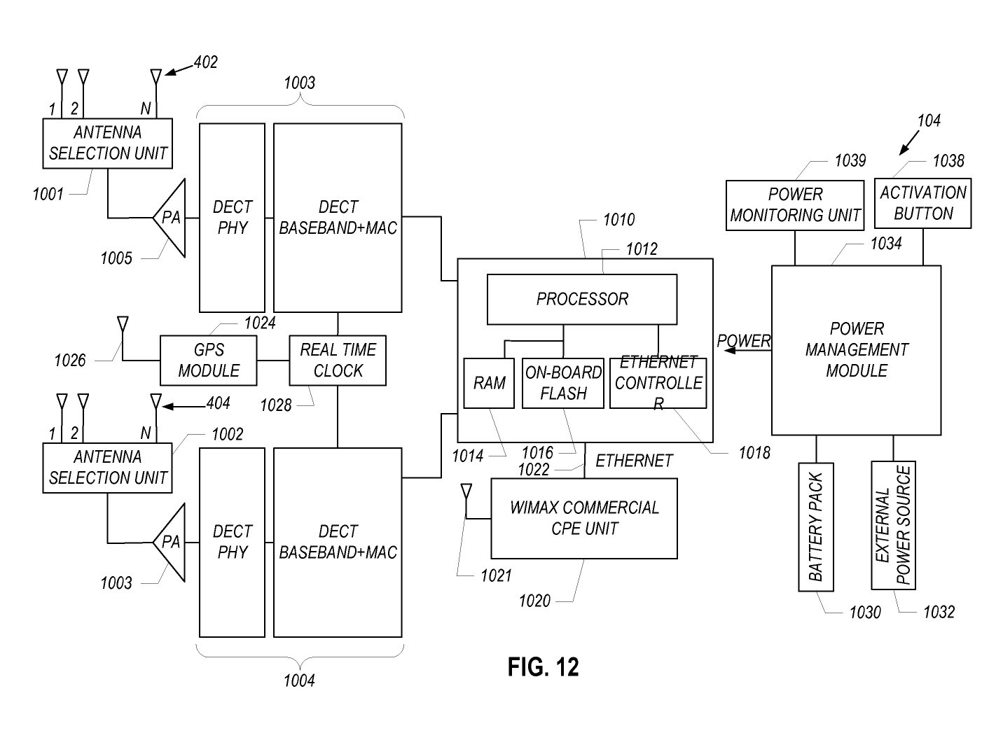

FIG. 12 shows exemplary components of a wireless concentrator 104. Each wireless concentrator 104 has two multi-element sectorized antenna subsystems 402 and 404, which are used for diversity gain, as well as reduction of co-channel interference with neighboring rows. An antenna selection unit 1001 is used for selecting the elements of the multi-element antenna 402, and an antenna selection unit 1002 is used for selecting the elements of the multi-element antenna 404. The antenna elements are selected to achieve on optimized signal quality within the cell and to reduce the co-channel interference with the neighboring cells.

The wireless concentrator 104 also includes a first DECT chipset 1003 that includes a DECT PHY (physical) device and a baseband plus MAC device. The baseband plus MAC device can be a commercial integrated circuit. Alternatively the baseband and the MAC functionality can be implemented in a programmable device such as a field programmable gate array (FPGA). The customized version of the DECT MAC is implemented within this device. The baseband plus MAC device is also used to control the antenna selection unit 1001. A first amplifier 1005 is provided between the DECT chipset 1003 and the antenna selection unit 1001.

The wireless concentrator 104 also includes a second DECT chipset 1004 coupled through a second amplifier 1006 to the antenna selection unit 1002.

A CPU 1010 is also provided in the wireless concentrator 104, where the CPU 1010 includes a processor 1012, a random access memory 1014, a flash memory 1016, and an Ethernet controller 1018. The RAM 1014 acts as a buffer for survey data and other information that are exchanged between the wireless survey receivers and the recording station. Executable code resides in the flash memory 1016. The CPU 1010 acts as a bridge between each DECT interface (DECT chipset 1003 or 1004) and the WiMAX interface (WiMAX CPE (customer premises equipment) unit 1020). The CPU 1010 is also responsible for performing auxiliary housekeeping functions. The flash memory 1016 can contain several MAC “profiles” (i.e. MAC firmware images). Among other things, the size and the number of the time slots within a time slot set, and the number of the time slot sets within a frame are implemented differently for each MAC profile. During the planning stage of a land survey operation, geophysical requirements as well as information about the terrain (gathered by the surveying team) are used to determine the most suitable MAC profile for the operation. The geophysical requirements such as sampling frequency and sample size are used to determine the size of the time slots. The information about the terrain is used to predict and analyze the propagation characteristics of the radio frequency signals in the area of operation. This information along with the receiver spacing requirements (that is also a part of the geophysical requirements) is used to define the radius of the cells (and therefore the number of the time slots within a time slot set). The signal propagation characteristics are also used to model the co-channel interference and determine the number of the time slot sets within a frame. Upon power up, the concentrator units will associate with a WiMAX base station and will eventually receive a command from the recoding station to download the most suitable MAC profile from the flash memory 1016 into the DECT chipsets 1003 and 1004.

The WiMAX CPE unit 1020 can be a commercially available unit. The WiMAX CPE unit 1020 interfaces with the rest of the wireless concentrator through an Ethernet interface 1022, in the example depicted in FIG. 12. The WiMAX CPE unit 1020 is connected to an antenna 1021 that physically resides on the wireless concentrator unit 104. Through the antenna 1022, the WiMAX CPE unit 1020 can communicate with a WiMAX base station 704.

The wireless concentrator 110 also includes a global positioning system (GPS) module 1024 that is connected to a GPS antenna 1026. The GPS module 1024 and GPS antenna 1026 allows the wireless concentrator 110 to communicate with GPS satellites for obtaining time synchronization information from the GPS satellites. The GPS module 1024 is connected to a real-time clock (RTC) 1028, and the GPS module 1024 allows the RTC 1028 to be time synchronized to the GPS time information. The synchronized time in the RTC 1028 can in turn be used to time-synchronize RTCs in the wireless survey receivers through the DECT interface.

The wireless concentrator 104 also includes a power management module 1034 to receive power from a battery pack 1030 and an external power source 1032. The power management module 1034 provides power to other components of the concentrator 104. The concentrator 104 also includes an activation button 1038 (for activating/deactivating the concentrator), and a power monitoring unit 1039 for providing an indication (e.g. LEDs or buzzers) of a power level in the concentrator 104.

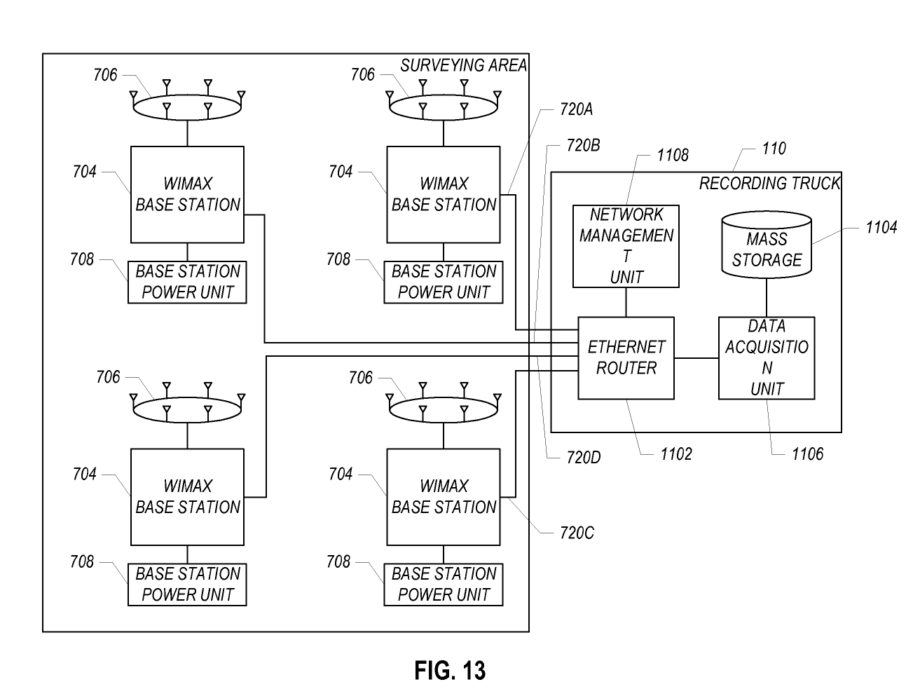

FIG. 13 shows exemplary components of the recording station 110 that is connected to a survey area including multiple WiMAX base stations 704. Each WiMAX base station 704 has a base station power unit 708 for providing power to the respective WiMAX base station. Each WiMAX base station is also connected to a sectorized antenna system 706 which in turn includes several antenna elements.

The WiMAX base station 704 is connected to an Ethernet router 1102 in the recording station 110 through the communication links 720A, 720B, 720C and 720D. The communication links 720A, 720B, 720C and 720D can be implemented as wire-based links (such as fiber optic cables links) or as wireless links (such as point-to-point microwave or free space optic links). Measurement data from wireless survey receivers is sent by the WiMAX base stations 704 to the recording station 110. A data acquisition unit 1106 records the received survey data in mass storage 1104. The data acquisition unit 1106 can also perform monitoring, tests, and control functions related to the spread equipment (wireless survey receivers, concentrators, and WiMAX base stations). The monitoring, tests, and control functions initiated by the data acquisition unit 1106 can be performed automatically or with human intervention.

The recording station 110 also includes a network management unit 1108 that is responsible for the management of the network. Among other services, the network management unit 1108 is responsible for address distribution and association and disassociation of DECT and WiMAX equipment within the network.

While the invention has been disclosed with respect to a limited number of embodiments, those skilled in the art, having the benefit of this disclosure, will appreciate numerous modifications and variations therefrom. It is intended that the appended claims cover such modifications and variations as fall within the true spirit and scope of the invention.

What is claimed is:

1. A method for use with a survey data acquisition system that acquires survey data regarding a subterranean structure, comprising:
wirelessly communicating information between a wireless survey receiver and a wireless concentrator in the survey data acquisition system that acquires survey data regarding the subterranean structure,
wherein wirelessly communicating the information comprises using a wireless protocol that employs slot structures defined by a Digital Enhanced Cordless Telecommunications (DECT) standard.

2. The method of claim 1, wherein the wireless protocol employs time division multiplexing in which a larger number of time slots are assigned for uplink communication from the wireless survey receiver to the wireless concentrator than for downlink communication from the wireless concentrator to the wireless survey receiver.

3. The method of claim 2, wherein the wireless protocol has a medium access control (MAC) layer that is modified from a MAC layer of the DECT standard.

4. The method of claim 3, wherein the wireless protocol employs a data rate per bearer for the MAC layer that is reduced with respect to a data rate specified by the DECT standard such that a number of bearers supported by one radio frequency is increased.

5. The method of claim 1, further comprising wirelessly communicating information between other wireless survey receivers and other wireless concentrators using the wireless protocol,
wherein the wireless concentrators provide respective coverage areas that make up cells to enable a cellular arrangement of wireless communications between the wireless survey receivers and the wireless concentrators.

6. The method of claim 1, wherein wirelessly communicating information between the wireless survey receiver and the wireless concentrator comprises communicating survey data from the wireless survey receiver to the wireless concentrator on a real-time basis.

7. The method of claim 1, wherein wirelessly communicating the information comprises wirelessly communicating the information in a DECT double-slot structure.

8. The method of claim 7, wherein wirelessly communicating the information in the DECT double-slot structure comprises dividing a packet containing survey data into multiple frames, wherein each frame has uplink double slots each according to the DECT double-slot structure, and downlink double slots each according to the DECT double-slot structure.

9. The method of claim 8, wherein the uplink double slots in each frame are used to communicate survey data of respective different survey receivers.

10. The method of claim 8, wherein the downlink double slots are used to communicate control and acknowledgement information from the wireless concentrator.

11. The method of claim 10, wherein the control information is broadcast from the wireless concentrator to multiple survey receivers.

12. The method of claim 1, further comprising the wireless concentrator communicating using a first carrier having a first frequency with a first group of survey receivers in a first sub-coverage area of the wireless concentrator, and communicating using a second carrier having a second, different frequency with a second group of survey receivers in a second sub-coverage area of the wireless concentrator.

13. The method of claim 12, further comprising:
using a frequency reuse pattern in a first row of survey receivers and wireless concentrators, and
using a shifted version of the frequency reuse pattern in a second adjacent row of survey receivers and wireless concentrators.

14. The method of claim 1, further comprising:
communicating backhaul information between the wireless concentrator and a recording station through a communications network that includes a cellular arrangement of base stations.

15. The method of claim 14, wherein communicating the backhaul information through the communications network that includes the cellular arrangement of base stations comprises communicating the backhaul information using WiMAX base stations.

16. The method of claim 15, further comprising:
each of the WiMAX base stations communicating wirelessly with a group of wireless concentrators; and
each of the WiMAX base stations communicating with the recording station.

17. A survey data acquisition system comprising:
wireless survey receivers to receive survey data affected by a subterranean structure; and
at least one wireless concentrator to communicate wirelessly with the wireless survey receivers using a wireless protocol that is based on a Digital Enhanced Cordless Telecommunications (DECT) communications technology

18. The survey data acquisition system of claim 17, wherein the wireless protocol employs time division multiplexing that assigns uplink time slots for uplink communication and downlink time slots for downlink communication, wherein a number of uplink time slots is greater than a number of downlink time slots.

19. The survey data acquisition system of claim 17, further comprising:
a recording station to receive the survey data sent by the wireless survey receivers through the at least one wireless concentrator.

20. The survey data acquisition system of claim 17, further comprising:
a wireless base station that is part of a cellular network to communicate the survey data from the at least one wireless concentrator to the recording station.

21. The survey data acquisition system of claim 20, wherein the wireless base station comprises a WiMAX base station.

22. The survey data acquisition system of claim 17, wherein the wireless concentrator has:
a first DECT chipset and a first directional multi-element antenna subsystem associated with the first DECT chipset to communicate using a first carrier having a first frequency, and
a second DECT chipset and a second directional multi-element antenna system associated with the second DECT chipset to communicate using a second carrier having a second, different frequency.

23. A wireless survey receiver comprising:
a sensor to receive survey data affected by a subterranean structure;
a wireless interface to send the survey data wirelessly to a wireless concentrator, wherein the wireless interface employs a wireless protocol that is based on a Digital Enhanced Cordless Telecommunications (DECT) communications technology.

24. The wireless survey receiver of claim 23, wherein the wireless protocol employs time division multiplexing that assigns uplink time slots for uplink communication and downlink time slots for downlink communication, wherein a number of uplink time slots is greater than a number of downlink time slots.

25. The wireless survey receiver of claim 23, wherein the sensor comprises one of an electromagnetic sensor and a seismic sensor.
